(19) United States
(12) Patent Application Publication
(10) Pub. No.: US 2010/0278302 A1
(43) Pub. Date: Nov. 4, 2010

(54) Apparatus for Detecting Specific Element

(75) Inventors: Jun Yokoyama, Ichikawa-shi (JP); Ryozo Ushio, Ishikawa-shi (JP); Koji Komatsu, Ichikawa-shi (JP)

Correspondence Address: EDWARDS ANGELL PALMER & DODGE LLP, P.O. BOX 55874, BOSTON, MA, 02205, US

(73) Assignees: SUMITOMO METAL MINING CO., LTD., Tokyo (JP); INTERNATIONAL CENTER FOR ENVIRONMENTAL TECHNOLOGY TRANSFER, Yokkaichi-shi, Mie (JP)

(21) Appl. No.: 11/991,742

(22) PCT Filed: Sep. 6, 2007
(86) PCT No.: PCT/JP2007/067773

§ 371 Date: Jul. 8, 2010

(30) Foreign Application Priority Data
Nov. 30, 2006 (JP) 2006-322816

(51) Int. Cl. G01N 23/223

(52) U.S. Cl. 378/45; 378/208

(57) ABSTRACT

An apparatus for detecting a specific element for detecting presence or content concentration of a specific element contained in a measurement target, which includes a raw material, such as soil or ore, a product in the form of powder, granule or gravel, and an intermediate product, a by-product, a waste material and the like generated during a process for producing the product, the apparatus comprising fluorescent X-ray measuring means that radiates an X-ray to the measurement target and measures a fluorescent X-ray generated thereby to detect the presence of the content concentration of the specific element, and film feeding means that inserts a resin film between a measuring window of the fluorescent X-ray measuring means and the measurement target, and feeds a fresh resin film between the measuring window and the measurement target along with repetition of detection of the specific element, whereby the intensity of the fluorescent X-ray can be prevented from being attenuated by measuring with the measuring window of the fluorescent X-ray measuring device in close contact with the measurement target through the resin film, the content concentration of the specific element in the order of several tens mg/kg can be accurately measured, and the measurement target can be prevented from being attached to the measuring window with the resin film.

### TECHNICAL FIELD

The present invention relates to an apparatus for detecting a specific element that is used in such a case as detecting presence or content concentration of a specific element contained in a measurement target, which includes a raw material, such as soil or ore, a product in the form of powder, granule or gravel, and an intermediate product, a by-product, a waste material and the like generated during a process for producing the product.

### BACKGROUND ART

There arises a severe problem in processing soil polluted with a heavy metal, such as lead, arsenic, hexavalent chromium, for example, in remains of factories. Such procedures have been generally practiced that the polluted soil excavated is immobilized, and the soil having the pollutants immobilized thereto is transported to a final disposal field and infilled therein as an industrial waste material. In recent years, however, owing to shortage of remaining soil infilling capacity of final disposal fields and promotion of recycling systems based on the concept of recycling society, such a method is receiving attention in that the pollutants, such as a heavy metal, are rinsed out, for example, by washing, and the cleaned soil is infilled in the original site, from which the soil has been excavated.

In remains of factories, for example, however, there is a part having a high pollution concentration eccentrically-located therein due to the characteristics of the pollutants or the like, and there are cases where the cleaning treatment cannot be efficiently carried out to bring about decrease in cleaning efficiency, depending on the treating capacity of the cleaning equipments used.

Furthermore, a specific element, such as a heavy metal, should be properly managed fundamentally from the standpoint of environmental protection, security and the like, and what should be checked for adequateness of management is not limited to the fields of soil pollution and remedy therefor.

For suppressing consumption of the resources to reduce burden on the environment by promoting efficient use of raw materials and recycling of the resources, it is necessary to manage properly the specific element, such as a heavy metal, and therefore, in the ordinary industrial fields other than the aforementioned fields, there are many cases where attention should be made on the presence or content concentration of the specific element contained in raw materials, products, waste materials and the like.

For example, in the field of producing cement, waste materials, such as coal ash, polluted sludge, polluted soil, are mixed as raw materials to cement for recycling the waste materials. Since content concentrations of harmful minor components are restricted for every waste material, only coal ash, polluted sludge, polluted soil and the like that meets the restricted values are only mixed, and cement having been subjected to proper process to attain sufficient quality management is shipped as a product. Accordingly, it is important in management of production process of cement to comprehend the content concentration of the specific element in a raw material.

In the field of refining, resources, such as ores, that have been difficult to refine by the conventional techniques due to low grade can be now utilized on a commercial basis owing to improvement in refining techniques. Accordingly, it is investigated to utilize ores efficiently by measuring the content concentration of the specific element in the ores in advance.

Under the circumstances, in recent years, such occasions and necessity are liable to increase that the content concentration of the specific element is measured for carrying out quality management, screening operation and the like, and for example, an apparatus using a detection result of a fluorescent X-ray on screening soil or the like has been known.

For example, Japanese Patent No. 3,698,255 (Patent Document 1) discloses a soil screening apparatus, in which the fluorescent X-ray generated by radiating an X-ray from a fluorescent X-ray measuring device to polluted soil fed with a belt conveyor is detected, and the polluted soil is screened by switching the discharge path thereof based on the detection result. In the apparatus, the concentration of the pollutant, such as a heavy metal, contained in the soil is measured by the intensity of the fluorescent X-ray detected, and the soil is screened based on the extent of the concentration.

Japanese Patent No. 3,696,522 (Patent Document 2) discloses a screening apparatus, in which an X-ray is radiated from a fluorescent X-ray measuring device to a waste material moving on a belt conveyor, and a fluorescent X-ray generated thereby is detected to detect the presence of the specific element contained in the waste material, which is screened based on the detection result.

The aforementioned fluorescent X-ray measuring device is to detect the specific element based on the fluorescent X-ray analysis, and the analysis method is such a quantitative analysis method in that an X-ray is radiated to a measurement target, and the intensity of a fluorescent X-ray, which is a kind of a secondary X-ray, generated from the measurement target is measured to detect the presence or the content concentration of the specific element in the measurement target. Furthermore, the fluorescent X-ray analysis is simple in measuring operation and requires a short measuring time, and thus is widely utilized in various fields.

### DISCLOSURE OF THE INVENTION

The fluorescent X-ray measuring device has the following problem.

In the case, for example, where a fluorescent X-ray generated by radiating an X-ray to a measurement target containing the specific element is measured by the fluorescent X-ray measuring device as described above, the intensity of the fluorescent X-ray may be attenuated when a large distance is provided between the measuring window for introducing the fluorescent X-ray of the measuring device and the measurement target.

In this case, even though the fluorescent X-ray is attenuated to some extents, the specific element can be detected when the content concentration thereof is in the order of several percents (in the order of several tens of thousands mg/kg), and the substantially accurate value can be obtained by multiplying the measured value of the detected fluorescent X-ray by a correction coefficient of the distance. In the case where the content concentration of the specific element is in the order of several tens mg/kg, on the other hand, the fluorescent X-ray is difficult to detect when the distance is increased, and an accurate measured value cannot be obtained. Accordingly, it is necessary to measure by making the measurement target in close contact with the measuring window.

In the case where the measurement target has a high water content, such as polluted sludge, however, the target is significantly liable to be attached to another member, and cannot be prevented from being attached to the measuring window when the measurement target is measured by making in close contact with the measuring window. In the case where the measurement is continuously carried out in the state where the target is in close contact with the measuring window, an accurate measured value cannot be obtained due to inhibition of irradiation of the X-ray and measurement of the fluorescent X-ray.

The opening of the measuring window is closed with a thin film of a polyester film or the like, which transmits the X-ray and the fluorescent X-ray, but the thin film generally has a thickness of only several micrometers, and when a material having sharp edges, such as ores or glass cullet, is measured, the thin film may be broken with the sharp measurement target.

In the fluorescent X-ray measuring device, furthermore, the spectral chamber containing the spectral device is maintained vacuum since the X-ray is absorbed by the air, and there may be such a case in that when the thin film of the measuring window is broken, the vacuum state of the spectral chamber connected to the measuring window is broken, and the measurement target is sucked to the interior of the apparatus through the opening of the measuring window, whereby the X-ray radiation part and the fluorescent X-ray detecting part are broken to damage the fluorescent X-ray measuring device itself, and the like.

The invention has been proposed in view of the problems mentioned above, and an object thereof is to provide such an apparatus for detecting a specific element that can detect accurately and certainly the presence or the content concentration of the specific element in the measurement target regardless of the shape and the state of the measurement target and the extent of the content of the specific element contained in the measurement target.

For attaining the object, the apparatus for detecting a specific element of the invention has the following constitution. An apparatus for detecting a specific element for detecting presence or content concentration of a specific element contained in a measurement target, which includes a raw material, such as soil or ore, a product in the form of powder granule or gravel, and an intermediate product, a by-product, a waste material and the like generated during a process for producing the product, characterized by comprising fluorescent X-ray measuring means that radiates an X-ray to the measurement target and measures a fluorescent X-ray generated thereby to detect the presence or the content concentration of the specific element, and film feeding means that inserts a resin film between a measuring window of the fluorescent X-ray measuring means, through which the fluorescent X-ray is introduced, and the measurement target, and feeds a fresh resin film between the measuring window and the measurement target along with repetition of detection of the specific element.

According to the constitution, in the invention, upon measuring the presence or the content concentration of the specific element in the measurement target by using the fluorescent X-ray measuring means, even in the case where the measurement target is measured by making the measurement target in close contact with the measuring window of the fluorescent X-ray measuring means through the resin film for preventing the intensity of the fluorescent X-ray from being attenuated, attachment of the measuring target to the measuring window and breakage of the measuring window and the like can be prevented with the resin film, and the content concentration of the specific element can be accurately and certainly measure even though it is in the order of several tens mg/kg. The measuring window can be protected with the resin film even in the case where a material having sharp edges is contained in the measurement target, and thus the detecting operation can be carried out stably and accurately for a prolonged period of time.

The measurement target may be transported with transporting means and stopped upon measuring with the fluorescent X-ray measuring means, the fluorescent X-ray measuring means may be supported in a state where the measuring window faces the measuring target, and may be movable with respect to the measuring target, radiation of an X-ray and measurement of a fluorescent X-ray may be carried out in a state where the transportation of the measurement target and the movement of the fluorescent X-ray measuring means are stopped, and the measuring window is in close contact with the measurement target through the resin film, and thereafter, a fresh resin film may be fed between the measuring window and the measuring target with the film feeding means when the measuring window of the fluorescent X-ray measuring means is apart from the measurement target.

After carrying out the measuring operation, a fresh resin film is fed between the measuring window of the fluorescent X-ray measuring means and the measurement target with the film feeding means, whereby such a state is maintained in that the measuring window is always protected with a resin film without contamination to enable measurement with high accuracy.

A scraper that removes the measurement target attached to the resin film may preferably provided on an upstream side of the position where the resin film is wound in a roll form on the downstream side of the measuring window in the transporting direction of the resin film.

By providing the scraper, the resin film is wound to a winding roll in a state where the measurement target attached to the resin film has been almost removed, whereby the resin film can smoothly move and can be used repeatedly for a prolonged period of time.

As the resin film, one of, for example, polyvinyl chloride, polyethylene, polyester and polyimide may be used.

Screening means that screens the measurement target into plural kinds corresponding to the detection result of the presence or the content concentration of the specific element in the measurement target measured with the fluorescent X-ray measuring means may be provided on the downstream side of the transporting means that transports the measurement target. The screening means may comprise plural discharge paths that the measurement target transported with the transporting means is discharged through, discharge path switching means that switches the discharge path of the measurement target corresponding to the detection result, and a controlling device that controls a switching operation of the discharge path switching means corresponding to the detection result.

### BRIEF DESCRIPTION OF THE DRAWINGS

FIG. 1 is an elevational view showing an embodiment of an apparatus for detecting a specific element according to the invention.

FIG. 2 is a side view of the apparatus for detecting a specific element.

FIG. 3 is an elevational view of a modified embodiment of the film feeding means of the apparatus for detecting a specific element.

FIG. 4 is a graph showing the relationship between the thickness of the resin film and the Pb concentration measured.

FIG. 5 is a side view showing an embodiment of an apparatus for detecting a specific element comprising screening means.

FIG. 6 is a side view showing another embodiment of an apparatus for detecting a specific element comprising screening means.

### BEST MODE FOR CARRYING OUT THE INVENTION

An apparatus for detecting a specific element according to the invention will be described specifically with reference to embodiments shown in the drawings.

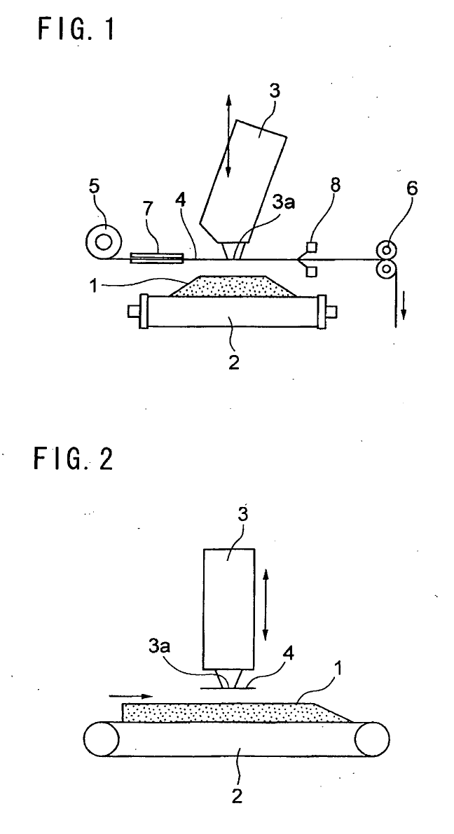

FIGS. 1 and 2 show the case where the apparatus for detecting a specific element according to the invention is applied to detection of a content concentration (heavy metal concentration) of a pollutant containing a heavy metal, such as lead, as the specific element from polluted soil as the measurement target.

In the embodiment, the polluted soil 1 as the measurement target is transported with a belt conveyor 2 as the transporting means, and a fluorescent X-ray measuring device 3, which radiates an X-ray to the polluted soil 1 and detects a fluorescent X-ray generated thereby for detecting the presence or the content concentration of the specific element, is provided above the midstream of the transporting path of the belt conveyor 2.

The polluted soil 1 transported with the belt conveyor 2 is stopped automatically or manually after the prescribed suspected area or the like has been transported to the position that faces the fluorescent X-ray measuring device 3.

The fluorescent X-ray measuring device 3 has inside a chassis an X-ray radiation part (which is not shown in the figures) that radiates an X-ray to the polluted soil 1 as the measurement target, and a fluorescent X-ray detecting part (which is not shown in the figures) that measures a fluorescent X-ray generated by the radiation of an X-ray, and a measuring window 3a, through which the X-ray and the fluorescent X-ray pass, is provided on the side of the measurement target, i.e., the side of the polluted soil 1, of the fluorescent X-ray measuring device 3.

The fluorescent X-ray measuring device 3 is supported with a supporting member or the like, which is not shown in the figures, in a state where the measuring window 3a faces suspected area or the like of the polluted soil 1 as the measuring target, and is movable (backward and forthward) against the polluted soil 1, or in the figures, is movable vertically, i.e., in the direction orthogonal (perpendicular) to the transporting direction of the polluted soil. For preventing the X-ray from being leaked, it is preferred to provide a shield (which is not shown in the figures) or the like formed of a material capable of shielding the X-ray, in the vicinity of the fluorescent X-ray measuring device 3 and the radiation position of the X-ray to cover them.

A resin film 4 is inserted between the measuring window 3a of the fluorescent X-ray measuring device 3 and the polluted soil 1 as the measurement target, and film feeding means is provided for feeding a fresh resin film 4 between the measuring window 3a and the polluted soil 1 along with repetition of the detecting operation of the pollutant containing a heavy metal, such as lead, as the specific element.

In the film feeding means in the embodiment, the resin film 4 in a long strip form having been wound on a delivery roll 5 in advance is fed between the measuring window 3a and the polluted soil 1 with plural driving rollers 6 (a pair of them in the figures) driven with a motor, which is not shown in the figures, to cover the measuring window 3a.

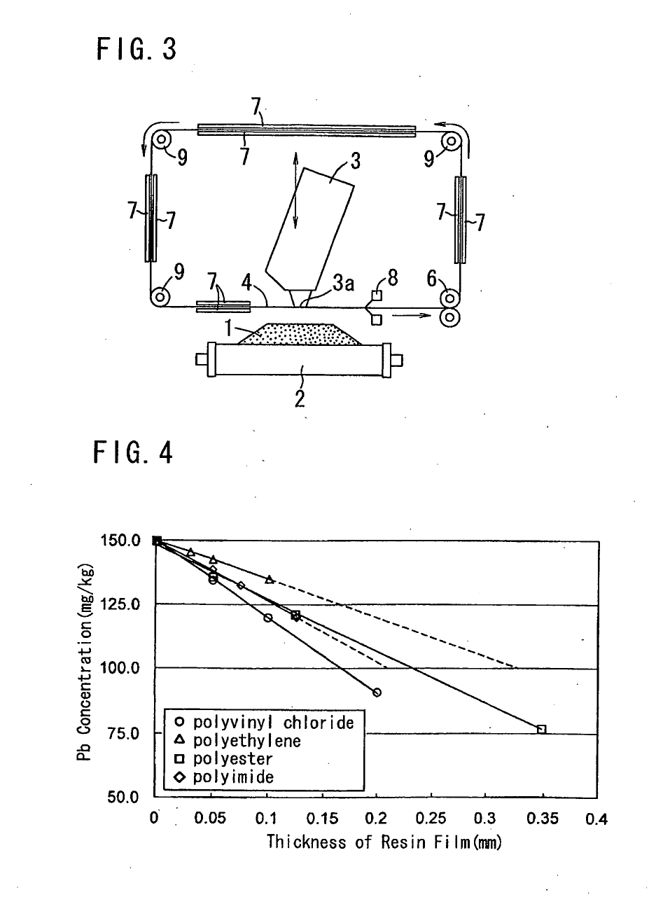

In the embodiment, the resin film 4 is fed (moved) in the direction substantially perpendicular to the transporting direction of the polluted soil 1 as the measurement target, i.e., the moving direction of the belt conveyor 2, but may be moved in the direction substantially in parallel to the transporting direction. The resin film 4 having passed through the driving rollers 6 is then turned downward and wound on a winding roll, which is not shown in the figures, but may be turned upward or may not be turned, and then wound on a winding roll, which is not shown in the figures. As shown in FIG. 3, the resin film 4 formed into an endless form may be disposed to surround the fluorescent X-ray detecting device 3, and rotationally driven with plural turning rollers 9 and the driving rollers 6.

It is preferred to provide guides 7 or the like that support the resin film 4 between the delivery roll 5 and the measuring window 3a, as shown in FIG. 1. The guides 7 in a flat plate form are disposed on the upside and downside of the resin film 4 to hold the resin film 4 from both the sides, and are provided closely to the measuring window 3a, whereby the resin film 4 is stably fed between the measuring window 3a and the polluted soil 1, and the resin film 4 is favorably protected from the scattering polluted soil 1.

It is preferred to provide a scraper 8 that removes the polluted soil 1 as the measurement target attached to the resin film, on the upstream side of the position where the resin film 4 is wound to a roll form on the downstream side of the measuring window 3a, i.e., on the upstream side of the winding roll, which is not shown in the figures, in the transporting direction of the resin film 4, as shown in FIG. 1.

By providing the scraper 8, the resin film 4 is wound on the winding roll in a state where the polluted soil 1 attached thereto has been almost removed, whereby the resin film 4 can smoothly move and can be used repeatedly for a prolonged period of time. The scrapers 8 may be disposed on the upside and downside of the resin film 4 to hold the resin film 4 from both the sides, whereby the stable running of the resin film 4 can be assisted. The material for the scraper 8 may be appropriately selected and can be produced, for example, with rubber, a resin, a metal or the like.

The resin film 4 may be a material that has a sufficient strength and a small attenuation of the fluorescent X-ray intensity and does not contain the specific element as the measurement target. For example, one of polyvinyl chloride, polyethylene, polyester and polyimide is preferred as described above, and among these, polyester is particularly preferred owing to excellent mechanical strength. The resin may be a natural resin, or may be a commodity resin, an engineering plastic material, a super engineering plastic material and the like, which are thermosetting resins or thermoplastic resins, and the fluorescent X-ray can be accurately measured by changing the resin film 4 depending on the element as the measurement target.

It is necessary that the thickness of the resin film 4 is determined in consideration of relationship to the material of the film and the attenuation of the fluorescent X-ray intensity. The following measurement results have been obtained for the influence of the thickness of the resin film 4 on the fluorescent X-ray measurement. In the measurement, soil having a lead content of 150 mg/kg is measured under a state where no resin film is inserted and a state where the four kinds of resin films with variation in thickness are inserted, and the results are shown in FIG. 4.

As apparent from FIG. 4, the lead content concentration is measured as lower values when the thickness of the resin film is increased, and thus it is necessary to compensate the measured value corresponding to the thickness and kind of the resin film. The fluorescent X-ray measuring device has a detection lower limit, and in the case where the measurement is carried out near the detection lower limit, there are cases where the accurate measured value cannot be obtained even though the compensation is effected. Accordingly, in the case where polluted soil having a lead concentration of 150 mg/kg as the measurement target is measured with the resin film inserted, the accurate measured value can be obtained with compensation unless the measured value is about several tens mg/kg or less, and preferably about 100 mg/kg or less. It is understood from the results in FIG. 4 that the thickness of the resin film is desirably about 0.3 mm or less, and more preferably about 0.2 minor less, for obtaining the accurate measured value. However, the thickness is necessarily at least 0.1 mm in consideration of the mechanical strength of the resin film.

Upon measuring the content concentration of the pollutant in the polluted soil 1 as the measurement target with the fluorescent X-ray measuring device 3 with the aforementioned constitution, the belt conveyor 2 transporting the polluted soil 1 is stopped, and the fluorescent X-ray measuring device 3 is moved downward to the position where the device is in close contact with the upper layer surface of the polluted soil 1. The driving rollers 6 moving the resin film 4 are stopped at this time. Under the state where the measuring window 3a of the fluorescent X-ray measuring device 3 is in close contact with the upper layer surface of the polluted soil 1 through the resin film 4, the content concentration of the pollutant is measured.

At this time, there is a large distance between the upper layer surface of the polluted soil 1 and the measuring window 3a of the fluorescent X-ray measuring device 3, the measured value cannot be accurately measured due to attenuation of the fluorescent X-ray intensity. Accordingly, the thickness of the layer of the polluted soil 1 and the descending distance of the fluorescent X-ray measuring device 3 are controlled in advance, whereby the measuring window 3a and the polluted soil 1 are made in close contact with each other with the resin film 4 inserted between them. The resin film 4 is supported in the state where it is always in close contact with the measuring window 3a, whereby the polluted soil 1 can be prevented from coming between the resin film 4 and the measuring window 3a.

After completing the measurement of the fluorescent X-ray in the aforementioned manner, the fluorescent X-ray measuring device 3 is moved upward, and simultaneously, the driving rollers 6 are rotated to move the resin film 4 in a prescribed length, whereby a clear part of the fresh resin film 4 in a strip form is fed to the position covering the measuring window 3a. The polluted soil 1 attached to the part of the resin film 4 that has been in close contact with the polluted soil 1 is removed with the scraper 8, and the resin film 4 is wound sequentially on the winding roll, which is not shown in the figures.

The belt conveyor 2 moves again the polluted soil 1 in a prescribed moving distance to move the next suspected area to the position facing the measuring window 3a, and the measuring operation is repeated. Thus, a fresh part of the resin film 4 is fed between the polluted soil 1 and the measuring window 3a of the fluorescent X-ray measuring device 3 by every measurement, whereby the content concentration of the pollutant containing a heavy metal, such as lead, contained in the polluted soil 1 as the measurement target can be measured repeatedly and continuously.

After measuring the content concentration of the pollutant containing a heavy metal, such as lead, i.e., the specific element, contained in the polluted soil 1 as the measurement target in the manner described above, screening means may be provided that screens the measurement target, such as polluted soil, corresponding to the measurement result.

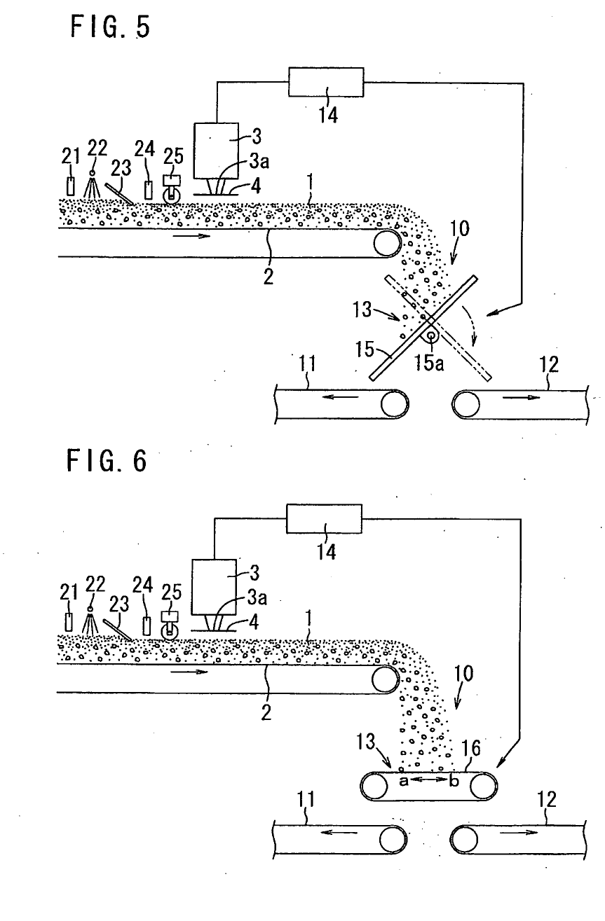

FIGS. 5 and 6 show embodiments of the apparatus for detecting a specific element equipped with the screening means, in which the members having the same functions as in FIGS. 1 and 2 are attached with the same symbols for omitting repeated descriptions.

In the embodiments shown in FIGS. 5 and 6, as similar to the embodiments shown in FIGS. 1 and 2, an X-ray is radiated from a fluorescent X-ray measuring device 3 as fluorescent X-ray measuring means to polluted soil 1 as a measurement target transported with a belt conveyor 2 as transporting means, and a fluorescent X-ray generated thereby is measured with the fluorescent X-ray measuring device 3 to detect presence or content concentration of a pollutant containing a heavy metal, such as lead, as the measurement target, with which screening means 10 is provided that screens the polluted soil 1 as the measurement target into plural kinds corresponding to the detection result.

The screening means 10 has, as shown in FIGS. 5 and 6, plural (two in the figures) discharge paths 11 and 12 that the polluted soil 1 transported with the belt conveyor 2 is discharged through, discharge path switching means 13 that switches the discharge path of the polluted soil 1 corresponding to the detection result, and controlling means 14 that controls a switching operation of the discharge path switching means 13 corresponding to the detection result.

In the embodiments shown in FIGS. 5 and 6, belt conveyors are used as the discharge paths 11 and 12, respectively, and an inclined guide plate 15 rotatable around a horizontal axis 15a as the center is used as the discharge path switching means 13 in the embodiment shown in FIG. 5.

The polluted soil 1 transported with the belt conveyor 2 is guided to the discharge path 11 when the inclined guide plate 15 is rotated to the position shown with the solid line, and is guided to the discharge path 12 when the inclined guide plate 15 is rotated to the position shown with the chained line, thereby being discharged to the prescribed discharge positions, respectively.

In the embodiment shown in FIG. 6, a counterrotatable belt conveyor 16, the rotating direction of which can be switched, is used as the discharge path switching means 13. The polluted soil 1 transported with the belt conveyor 2 is guided to the discharge path 11 when the belt conveyor 16 is rotated in the direction shown by the arrow a in the figure, and is guided to the discharge path 12 when the belt conveyor 16 is rotated in the direction shown by the arrow b in the figure, thereby being discharged to the prescribed discharge positions, respectively.

The switching operation of the inclined guide plate 15 or the counterrotatable belt conveyor 16 as the discharge path switching means 13 is controlled with the controlling device 14 based on the measurement result by the fluorescent X-ray measuring device 3. Specifically, for example, in the case where the presence or the content concentration of the specific element is detected from the measured value of the fluorescent X-ray measuring device 3 with a data processing part of the controlling device 14 to determine that the specific element is contained or the content concentration thereof exceeds a prescribed value, the device is configured in such a manner that the measurement target at the position where the data has been measured and within the prescribed range around the position is discharged to the belt conveyor for transporting the measurement target having a high concentration, for example, the belt conveyor 11, upon discharging from the end of the belt conveyor 2, and in the case where it is determined that the specific element is not contained or the content concentration thereof is smaller than a prescribed value, the device is configured in such a manner that the measurement target at the position where the data has been measured and within the prescribed range around the position is discharged to the belt conveyor for transporting the measurement target having a low concentration, for example, the belt conveyor 12.

The discharge path switching means 13 can switch the polluted soil (measurement target) at the measured position based on every single measurement by the fluorescent X-ray measuring device 3 by the control with the controlling device 14, and can also switch for every region where plural measurements are carried out. That is, plural measurements may be carried out with the fluorescent X-ray measuring device 3 with prescribed intervals on the belt conveyor 2, and the measurement target including the measured points may be switched in block for the discharge paths based on the average value of the measurements.

In FIGS. 5 and 6, numeral 21 denotes a water content measuring device for measuring the water content of the polluted soil 1 transported with the belt conveyor 2, 22 denotes a spray for spraying water to the polluted soil 1 when the water content measured with the water content measuring device 21 is a prescribed value or less, 23 denotes a leveling plate (scraper) for smoothly leveling the surface of the polluted soil 1 transported with the belt conveyor 2, 24 denotes a water content measuring device for measuring the water content of the polluted soil 1 having water sprayed thereto with the spray 22, and 25 denotes a packing roller for pressing and flattening the surface of the polluted soil 1, which may be provided depending on necessity. These may also be provided in the embodiments shown in FIGS. 1 and 2 depending on necessity.

In the embodiments shown above, while belt conveyors are used as the transporting means and the discharge paths for the measurement target, such as the polluted soil, a pallet conveyor or the like may be appropriately used, and for example, a measurement target may be timely extracted or collected and placed on a tray or the like, and may be then transported under the fluorescent X-ray measuring device 3 to measure the fluorescent X-ray or discharged.

In the embodiments shown above, while such a case has been described as an example where a content concentration of a pollutant containing a heavy metal, such as lead, as the specific element in polluted soil as the measurement target is detected, the invention is not limited to the embodiments where presence or content concentration of a pollutant is measured and detected, and presence or content concentrations of other specific elements contained in various kinds of measurement targets can be measured and detected.

Examples of the measurement target in the invention include, in addition to soil mentioned above, a raw material, an intermediate product, a product, a by-product, a waste product and the like. More specifically, examples thereof include cement, ore, glass, incinerated ash, coal ash, sludge, polluted sludge, an inorganic material or an organic material in the form of granule or gravel, and the like.

The specific element may be an element that generates a fluorescent X-ray on radiation of an X-ray, and for example, aluminum, silicon, sulfur, chlorine, calcium, titanium, vanadium, chromium, manganese, iron, cobalt, nickel, copper, zinc, arsenic, selenium, bromine, rubidium, strontium, molybdenum, palladium, silver, cadmium, tin, antimony, platinum, gold, mercury, lead, bismuth and the like may be applied as the specific element in the invention.

It has been considered that elements of atomic numbers of from 12 to 92 can be measured for content concentration thereof by measuring an fluorescent X-ray generated on radiation of an X-ray, and thus can be included in the specific element that the invention targets as similar to the aforementioned elements. Furthermore, there is such a possibility that the species of elements that can be included in the specific element is expanded beyond the aforementioned range of the atomic number depending on future improvement of the measurement technique.

### Examples

### Example 1

Two kinds of lead-polluted soil A and B were measured for lead content concentration by using a fluorescent X-ray measuring device. The soil A and the soil B were measured respectively in the state where a resin film was not inserted between the measuring window of the fluorescent X-ray measuring device and the lead-polluted soil, and the lead content concentration ratio of the soil A to the soil B was 2/1. Next, without a resin film inserted similarly, the soil A was measured after measuring the soil B, and the soil B was measured after measuring the soil A, respectively in the state where the measuring window was in close contact with the lead-polluted soil.

The measured value of the lead content concentration of the soil A when the soil A was measured after measuring the soil B was 0.63 with respect to the lead content concentration of the soil A being 1.00. The measured value of the lead content concentration of the soil B when the soil B was measured after measuring the soil A was 2.53 with respect to the lead content concentration of the soil B being 1.00. In both the cases, accurate measurement for content concentration could not be carried out since the lead-polluted soil that had been measured lastly was attached to the measuring window to exert influence of the lead content concentration in the attached soil.

A resin film was then inserted between the measuring window of the fluorescent X-ray measuring device and the lead-polluted soil, and the two kinds of lead-polluted soil A and B above were measured in the state where the measuring window and the resin film were in close contact with each other, and the resin film and the lead-polluted soil were in close contact with each other. As the resin film in this case, polyvinyl chloride, polyethylene, polyester and polyimide each having a thickness of 0.1 mm were used.

Table 1 below shows measured values of the lead content concentration of the soil A and the soil B obtained with the resin film inserted as relative values with respect to the measured values (standard values) of the lead content concentration of the soil A and the soil B measured with the resin film not inserted being 1.00. The measured values of the lead content concentration shown in Table 1 are values having been compensated for attenuation by the resin film.

TABLE 1

| | |
|---|---|
| Measured value of | Measured value of |
| lead content | lead content |
| concentration of soil A | concentration of soil B |

| | | | |
|---|---|---|---|
| Soil A (standard value) | 1.00 | Soil B (standard value) | 1.00 |

| | |
|---|---|
| With resin film fed | With resin film fed |

| | | | |
|---|---|---|---|
| Polyvinyl chloride | 0.94 | Polyvinyl chloride | 1.06 |
| Polyethylene | 0.95 | Polyethylene | 1.05 |
| Polyester | 1.02 | Polyester | 0.98 |
| Polyimide | 0.98 | Polyimide | 1.02 |

It was understood from Table 1 that the measured values of the lead content concentration of the soil A and the soil B measured in the state where the resin film was inserted between the measuring window of the fluorescent X-ray measuring device and the lead-polluted soil was within a range of about ±10% of 1.00 as the standard lead content concentration of the soil A and soil B for all the resin films. Accordingly, accurate measurement can be carried out by inserting the resin film to the measuring window of the fluorescent X-ray measuring device.

### Example 2

A soil measuring test was carried out by using an apparatus for measuring a specific element shown in FIGS. 1 and 2. Lead-polluted soil 1 as the measurement target having a particle diameter of 10 mm or less in a water containing state was transported with a belt conveyor 2 and flattened on the upper surface of the soil, and a polyester film of 0.1 mm as a resin film 4 was fed between the polluted soil and a measuring window 3a of the fluorescent X-ray measuring device 3. Upon stopping the belt conveyor 2, the fluorescent X-ray measuring device 3 was moved downward, and the lead content concentration was measured in the state where the measuring window 3a and the lead-polluted soil were in close in contact with each other through the resin film 4. Thereafter, the fluorescent X-ray measuring device 3 is moved upward, the resin film 4 was moved and wound to a prescribed length, and the lead-polluted soil was transported with the belt conveyor 2.

The aforementioned operation was repeated to carry out the soil measuring test for 8 hours per day. The test was carried out by using the apparatus for detecting a specific element in a state where a scraper 8 was provided or not provided.

In the test without the scraper 8, the soil attached to the resin film 4 migrated to the driving rollers 6, the amount of the soil attached to the driving rollers was increased with the lapse of time, and the soil was solidified to inhibit the rotation of the driving rollers 6. In the case where the attached soil contained gravel, the driving rollers 6 bit the gravel to stop rotation. Consequently, the apparatus had to be stopped for washing the driving rollers 6 five times within the test over 8 hours.

In the test with the scraper 8 provided, the soil attached to the resin film 4 was entirely removed with the scraper 8 before the driving rollers 6. Consequently, the soil could be measured with the apparatus never stopped within the test over 8 hours. No problem occurred in the stable feed of the resin film 4 with the guide 7 and the cooperation of downward and upward movements of the fluorescent X-ray measuring device 3 and the resin film 4 within the test over 8 hours.

### Example 3

A measurement test was carried out in such a manner that four kinds of lead-polluted soil, Test Nos. 1 to 4, were measured for content concentration of lead (Pb) contained in the lead-polluted soil in the same manner as in Example 2. The results are shown in Table 2 below.

TABLE 2

| Test | Pb measured | Pb guaranteed | Relative |
|---|---|---|---|
| No. | value (mg/kg) | value (mg/kg) | error (%) |
| 1 | 330 | 300 | 10.0 |
| 2 | 290 | 270 | 7.4 |
| 3 | 1,100 | 1,300 | 15.4 |
| 4 | 910 | 990 | 8.1 |

In the measurement test, about 200 kg each of the four kinds of lead-polluted soil, Test Nos. 1 to 4, transported with a belt conveyor were subjected for fluorescent X-ray measurement five times on the belt conveyor, and the measured values in the table showed average values of the five measured values of the lead content concentration obtained by fluorescent X-ray measurement in Test Nos. 1 to 4. The guaranteed values showed lead content concentration values measured in such a manner that soil collected from five different positions selected from the bulk lead-polluted soil of about 200 kg used in the aforementioned measurement tests were mixed and measured in the wet chemical analysis method, which was commonly used for measuring content concentration of pollutant. The relative error was obtained by dividing the absolute value of the difference between the measured value and the guaranteed value by the guaranteed value.

It is understood from Table 2 that the apparatus for detecting a specific element according to the invention enables measurement of lead-polluted soil with a small error as compared to the measurement results of the conventional wet chemical analysis method.

### Example 4

A measurement test for content concentration of nickel (Ni) was carried out in the same manner as in Example 3 except that four kinds of nickel ore, Test Nos. 1 to 4, instead of the lead-polluted soil in Example 3.

TABLE 3

| Test | Ni measured | Ni guaranteed | Relative |
|---|---|---|---|
| No. | value (mg/kg) | value (mg/kg) | error (%) |
| 1 | 19,000 | 17,000 | 11.8 |
| 2 | 18,000 | 16,000 | 12.5 |
| 3 | 21,000 | 23,000 | 8.7 |
| 4 | 22,000 | 20,000 | 10.0 |

It is understood from Table 3 that the apparatus for detecting a specific element according to the invention enables measurement of content concentration of nickel in nickel ore with a small error.

### Example 5

A measurement test for content concentrations of lead (Pb), copper (Cu) and zinc (Zn) as specific elements was carried out in the same manner as in Example 3 except that four kinds of fly ash, Test Nos. 1 to 4, instead of the nickel ore in Example 4. The results are shown in Table 4 below.

TABLE 4

| | Measured value | | | Guaranteed value | | | Relative error | | |
|---|---|---|---|---|---|---|---|---|---|
| Test | (mg/kg) | | | (mg/kg) | | | (%) | | |
| No. | Pb | Cu | Zn | Pb | Cu | Zn | Pb | Cu | Zn |
| 1 | 910 | 370 | 3,700 | 820 | 320 | 3,100 | 11.0 | 15.6 | 19.4 |
| 2 | 760 | 340 | 3,300 | 700 | 300 | 2,900 | 8.6 | 13.3 | 13.8 |
| 3 | 880 | 290 | 3,600 | 790 | 270 | 3,200 | 11.4 | 7.4 | 12.5 |
| 4 | 740 | 290 | 3,300 | 690 | 250 | 3,000 | 7.2 | 16.0 | 10.0 |

It is understood from Table 4 that the apparatus for detecting a specific element according to the invention enables measurement of content concentrations of lead, copper and zinc as specific elements in fly ash with a small error.

### Example 6

A measurement test for content concentration of lead (Pb) as a specific element was carried out in the same manner as in Example 3 except that four kinds of liquid slag, Test Nos. 1 to 4, instead of the fly ash in Example 5. The results are shown in Table 5 below.

TABLE 5

| Test | Pb measured | Pb guaranteed | Relative |
|---|---|---|---|
| No. | value (mg/kg) | value (mg/kg) | error (%) |
| 1 | 130 | 120 | 8.3 |
| 2 | 150 | 130 | 15.4 |
| 3 | 230 | 210 | 9.5 |
| 4 | 190 | 220 | 13.6 |

It is understood from Table 5 that the apparatus for detecting a specific element according to the invention enables measurement of content concentrations of lead and the like as specific elements in liquid slug with a small error.

### INDUSTRIAL APPLICABILITY

As shown by the embodiments and examples shown above, the apparatus for detecting a specific element according to the invention having the aforementioned constitution can measure presence or content concentration of a specific element in various kinds of measurement targets including not only polluted soil containing a pollutant containing a heavy metal, such as lead, but also a raw material, such as ore, a product in the form of powder, granule or gravel, and an intermediate product, a by-product, a waste product and the like generated during the process for producing the product, that contain the specific element, i.e., an element that generates a fluorescent X-ray on radiation of an X-ray. Accordingly, it has a wide applicable technical field and high industrial applicability.

1. An apparatus for detecting a specific element for detecting presence or content concentration of a specific element contained in a measurement target,
characterized by providing transporting means that transports the measurement target,
providing fluorescent X-ray measuring device that radiates an X-ray to the measurement target and measures a fluorescent X-ray generated thereby to detect the presence or the content concentration of the specific element, above midstream of a transporting path of the transporting means,
inserting a resin film between a measuring window of the fluorescent X-ray measuring device, through which the fluorescent X-ray is introduced, and the measurement target on the transporting means, and
feeding a clear part of the fresh resin film between the measuring window and the measurement target along with repetition of detection of the specific element.

2. The apparatus for detecting a specific element according to claim 1, characterized in that the resin film is fed in a direction substantially perpendicular to a moving direction of the transporting means.

3. The apparatus for detecting a specific element according to claim 1, characterized by
providing a guide in a flat plate form to hold the resin film from both sides between a delivery roll that feeds the resin film and the measuring window, and
providing the guide closely to the measuring window.

4. The apparatus for detecting a specific element according to claim 1, characterized by providing a scraper that holds the resin film from both sides and removes the measurement target attached to the resin film, on an upstream side of a position where the resin film is wound in a roll form on a downstream side of the measuring window in a transporting direction of the resin film.

5. The apparatus for detecting a specific element according to claim 1, characterized in that the measurement target is transported and stopped upon measuring with the-fluorescent X-ray measuring device,
the fluorescent X-ray measuring device is supported in a state where the measuring window faces the measuring target, and is movable with respect to the measuring target,
radiation of an X-ray and measurement of a fluorescent X-ray are carried out in a state where the transportation of the measurement target and the movement of the fluorescent X-ray measuring device are stopped, and the measuring window is in close contact with the measurement target through the resin film, and
thereafter, a clear part of the fresh resin film is fed between the measuring window and the measuring target when the measuring window of the fluorescent X-ray measuring device is apart from the measurement target.

6. The apparatus for detecting a specific element according to claim 1, characterized by providing plural discharge paths that the measurement target transported is discharged through, and a rotatable guide plate or a counterrotatable belt conveyor that switches the discharge paths corresponding to a detection result, on the downstream side as compared with the fluorescent X-ray measuring device in the transporting direction of the measurement target, and
screening the measurement target into plural kinds by controlling a switching operation of the inclined guide plate or the counterrotatable belt conveyor by a controlling device corresponding to the detection result of the presence or the content concentration of the specific element in the measurement target by the fluorescent X-ray measurement device.

7. The apparatus for detecting a specific element according to claim 1, characterized by
using polluted soil as the measurement target, and
providing, in this order, a water content measuring device that measures a water content of the polluted soil,
a spray that sprays water to the polluted soil when the water content measured with the water content measuring device is a prescribed value or less,
a leveling plate that smoothly levels a surface of the polluted soil, and
a packing roller that presses and flattens the surface of the polluted soil, on the transporting path on an upstream side of the measuring window.

8. The apparatus for detecting a specific element according to claim 2, characterized by
providing a guide in a flat plate form to hold the resin film from both sides between a delivery roll that feeds the resin film and the measuring window, and
providing the guide closely to the measuring window.

9. The apparatus for detecting a specific element according to claim 2, characterized by providing a scraper that holds the resin film from both sides and removes the measurement target attached to the resin film, on an upstream side of a position where the resin film is wound in a roll form on a downstream side of the measuring window in a transporting direction of the resin film.

10. The apparatus for detecting a specific element according to claim 2, characterized in that
the measurement target is transported and stopped upon measuring with the-fluorescent X-ray measuring device,
the fluorescent X-ray measuring device is supported in a state where the measuring window faces the measuring target, and is movable with respect to the measuring target,
radiation of an X-ray and measurement of a fluorescent X-ray are carried out in a state where the transportation of the measurement target and the movement of the fluorescent X-ray measuring device are stopped, and the measuring window is in close contact with the measurement target through the resin film, and
thereafter, a clear part of the fresh resin film is fed between the measuring window and the measuring target when the measuring window of the fluorescent X-ray measuring device is apart from the measurement target.

11. The apparatus for detecting a specific element according to claim 2, characterized by providing plural discharge paths that the measurement target transported is discharged through, and a rotatable guide plate or a counterrotatable belt conveyor that switches the discharge paths corresponding to a detection result, on the downstream side as compared with the fluorescent X-ray measuring device in the transporting direction of the measurement target, and
screening the measurement target into plural kinds by controlling a switching operation of the inclined guide plate or the counterrotatable belt conveyor by a controlling device corresponding to the detection result of the presence or the content concentration of the specific element in the measurement target by the fluorescent X-ray measurement device.

12. The apparatus for detecting a specific element according to claim 2, characterized by
using polluted soil as the measurement target, and
providing, in this order, a water content measuring device that measures a water content of the polluted soil,
a spray that sprays water to the polluted soil when the water content measured with the water content measuring device is a prescribed value or less,
a leveling plate that smoothly levels a surface of the polluted soil, and
a packing roller that presses and flattens the surface of the polluted soil, on the transporting path on an upstream side of the measuring window.
